(19) United States
(12) Patent Application Publication
(10) Pub. No.: US 2011/0309682 A1
(43) Pub. Date: Dec. 22, 2011

(54) SWITCHING POWER SUPPLY CIRCUIT

(75) Inventor: Akiteru CHIBA, Niiza-shi (JP)

(73) Assignee: Sanken Electric Co., Ltd., Niiza-shi (JP)

(21) Appl. No.: 13/109,081

(22) Filed: May 17, 2011

(30) Foreign Application Priority Data
Jun. 17, 2010 (JP) 2010-138282

(51) Int. Cl. H02M 3/335

(52) U.S. Cl. 307/75; 363/21.09

(57) ABSTRACT

The present invention includes: a first series circuit which is connected between one end and the other end of a DC power supply, and in which a reactor, a first diode, and a first capacitor are connected in series; a first switching element connected between the one end of the DC power supply and a connection point between the reactor and the first diode; a second series circuit which is connected to the first diode in parallel, and in which a second switching element and a second capacitor are connected in series; and a control circuit configured to control the on and off of the second switching element in order that turn on of the first switching element becomes to zero-voltage switching.

### TECHNICAL FIELD

The present invention relates to a switching power supply circuit capable of reducing switching loss of a switching element.

### BACKGROUND ART

A boost-type switching power supply circuit has been known heretofore. FIG. 1 is a diagram showing an example of a conventional boost-type switching power supply circuit. In FIG. 1, a series circuit including a primary winding 1a of a reactor L1, a switching element Q1 formed of a MOSFET (Metal Oxide Semiconductor Field Effect Transistor), and a current detection resistor R1 is connected to both ends of a DC (direct current) power supply Vin.

A parallel circuit including a diode Da and a capacitor Ca is connected to a drain and a source of the switching element Q1. The diode Da may be formed of a parasitic diode of the switching element Q1, and the capacitor Ca may be formed of a parasitic capacitor of the switching element Q1.

A series circuit including a rectifying diode D1 and a smoothing capacitor C1 is connected to a series circuit including the switching element Q1 and the current detection resistor R1. The control circuit 100 turns on and off the switching element Q1 based on a voltage from a criticality detection winding 1b of the reactor L1, a voltage from the smoothing capacitor C1, and a voltage from the current detection resistor R1, and thus makes control to output an output voltage Vo which is a constant voltage higher than an input voltage (voltage of the DC power supply Vin).

Next, operations of parts of the conventional boost-type switching power supply circuit will be described with reference to FIG. 2. First, during a period (T2 and T3) when the switching element Q1 is based on a gate signal Q1g, a current Q1i of the switching element Q1 and a current L1i of the reactor L1 linearly increase while flowing in a path from the positive electrode to the negative electrode of the DC power supply Vin via the reactor L1, the switching element Q1 and the current detection resistor R1.

In a period T4, once the switching element Q1 is turned off, a voltage Q1v between the drain and the source of the switching element Q1 increases, and the current L1i of the reactor L1 decreases. Next, in a period T5, a current D1i of the rectifying diode D1 and the current L1i of the reactor L1 gradually decrease while flowing in a path from the positive electrode to the negative electrode of the DC power supply Vin via the reactor L1, the rectifying diode D1 and the smoothing capacitor C1.

In periods T6 to T2, after excitation energy of the reactor L1 is released, voltage quasi resonance is generated by the reactor L1 and the capacitor Ca connected to the switching element Q1 in parallel. Accordingly, after the voltage Q1v of the switching element Q1 decreases to zero volts, the switching element Q1 is turned on, and thus zero-voltage switching (ZVS) can be achieved.

However, when a load is light, or when the input voltage (voltage of the DC power supply Vin) is high, as shown in a period T6 of FIG. 3, the voltage Q1v (quasi resonance voltage) of the switching element Q1 does not decrease to zero volts before the switching element Q1 is turned on. In this case, the capacitor Ca is short-circuited, and hard switching is performed. Thus, switching loss becomes large. In other words, a highly efficient switching power supply circuit cannot be achieved.

A conventional switching power supply circuit described in Japanese Patent Application Publication No. 2004-327152 includes, in addition to the configuration of the conventional switching power supply circuit shown in FIG. 1, a resonance reactor L2 (not shown) connected between a reactor L1 and a rectifying diode D1, and includes a series circuit (not shown) including a switching element Q2 and a capacitor C2, which is connected to both ends of the resonance reactor L2.

This switching power supply circuit reduces switching loss in the turning-on and turning-off of the switching elements Q1, Q2, because the switching power supply circuit performs zero-voltage switching when turning on the switching elements Q1, Q2, and gradually raises the voltage when turning off the switching elements Q1, Q2.

However, the conventional switching power supply circuit described in Japanese Patent Application Publication No. 2004-327152 allows a voltage between a drain and a source of the switching element Q2 to become larger than the voltage of the smoothing capacitor C1, and, in some cases, to exceed a breakdown voltage of the switching element Q2, because the switching power supply circuit is provided with the resonance reactor L2 in parallel with the switching element Q2.

### SUMMARY OF INVENTION

An object of the present invention is to provide a highly efficient switching power supply circuit by achieving a resonance operation in a wider input voltage range and load region by using a conventional reactor without provision of a resonance reactor.

The switching power supply circuit of the present invention includes: a first series circuit which is connected between one end and the other end of a DC power supply, and in which a reactor, a first diode, and a first capacitor are connected in series; a first switching element connected between the one end of the DC power supply and a connection point between the reactor and the first diode; a second series circuit which is connected to the first diode in parallel, and in which a second switching element and a second capacitor are connected in series; and a control circuit configured to control on and off of the second switching element in order that turn on of the first switching element becomes to zero-voltage switching.

### BRIEF DESCRIPTION OF DRAWINGS

FIG. 1 is a diagram showing an example of a conventional boost-type switching power supply circuit.

FIG. 2 is a diagram showing waveforms of the respective parts which are observed when quasi resonance is generated in the conventional boost-type switching power supply circuit shown in FIG. 1.

FIG. 3 is a diagram showing waveforms which are observed when a surge current occurs while the conventional boost-type switching power supply circuit shown in FIG. 1 is operating with a light load.

FIG. 4 is a configuration diagram of a switching power supply circuit of Example 1 of the present invention.

FIG. 5 is a waveform chart showing operations of the respective parts of the switching power supply circuit of Example 1 of the present invention.

FIGS. 6A to 6F are diagrams each showing a current path, in a bold line, which is established when the parts of the switching power supply circuit of Example 1 of the present invention operate in a corresponding period.

FIGS. 7A to 7D are diagrams each showing a current path, in a bold line, which is established when the parts of the switching power supply circuit of Example 1 of the present invention operate in a corresponding period.

FIG. 8 is a diagram showing an example of a control circuit of the switching power supply circuit of Example 1 of the present invention in detail.

FIG. 9 is a diagram showing how the control circuit shown in FIG. 8 makes control to turn on and off a switching element Q2 in accordance with a load state.

FIG. 10 is a diagram showing a control circuit provided in a switching power supply circuit of Example 2 of the present invention.

FIG. 11 is a configuration diagram of a switching power supply circuit of Example 3 of the present invention.

FIG. 12 is a diagram showing a control circuit provided in the switching power supply circuit of Example 3 of the present invention.

FIG. 13 is a diagram showing a control circuit provided in a switching power supply circuit of Example 4 of the present invention.

### DESCRIPTION OF EMBODIMENTS

A switching power supply circuit of an embodiment of the present invention will be described below in detail with reference to the drawings.

### Example 1

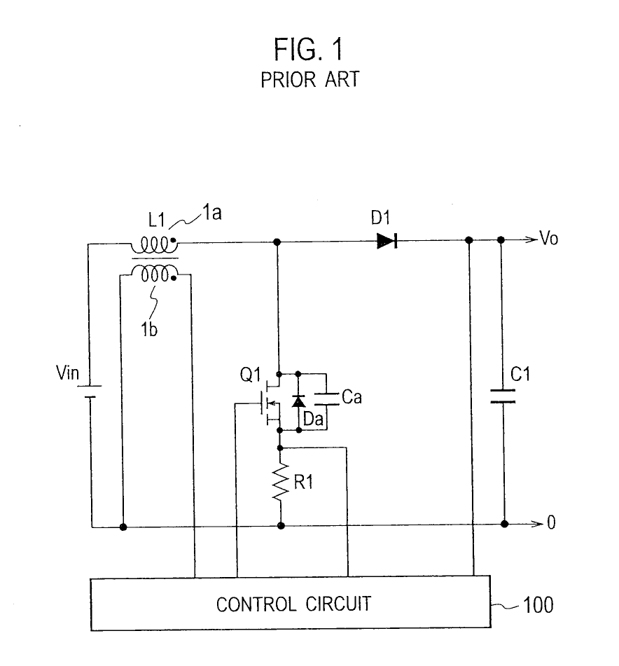

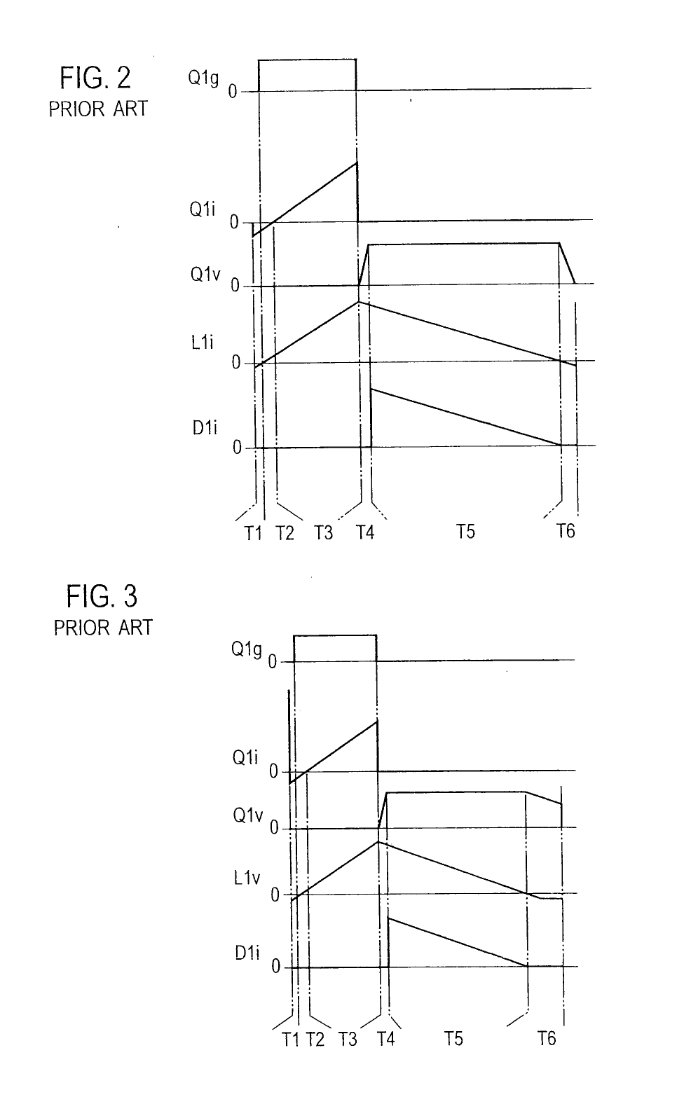

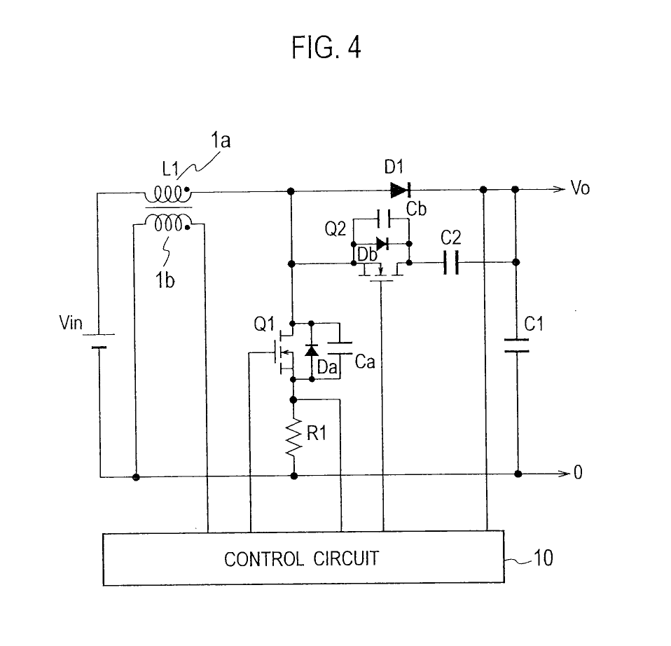

FIG. 4 is a configuration diagram of a switching power supply circuit of Example 1 of the present invention. The switching power supply circuit of Example 1 shown in FIG. 4 is a boost chopper circuit of a discontinuous current mode (critical type) in which a switching element Q1 is turned on after a current flowing through a reactor L1 reduces to zero. The switching power supply circuit is characterized in that, in addition to the configuration of the conventional switching power supply circuit shown in FIG. 1, a series circuit (second series circuit) including a switching element Q2 (second switching element) formed of a MOSFET and a capacitor C2 (second capacitor) is connected to a rectifying diode D1 (first diode) in parallel.

A parallel circuit including a diode Db and a capacitor Cb is connected between a drain and a source of the switching element Q2. A parasitic diode of the switching element Q2 may be substituted for the diode Db, and a parasitic capacitor of the switching element Q2 may be substituted for the capacitor Cb.

A control circuit 10 generates a gate signal Q1g based on a voltage from a criticality detection winding 1b of the reactor L1, a voltage from a smoothing capacitor C1, and a voltage from a current detection resistor R1. The control circuit 10 then outputs the gate signal Q1g to a gate of the switching element Q1 (first switching element), and thus turns on and off the switching element Q1.

The control circuit 10 generates a gate signal Q2g by inverting the gate signal Q1g used to turn on and off the switching element Q1. The control circuit 10 outputs the gate signal Q2g to a gate of the switching element Q2 (second switching element), and thus turns on and off the switching element Q2.

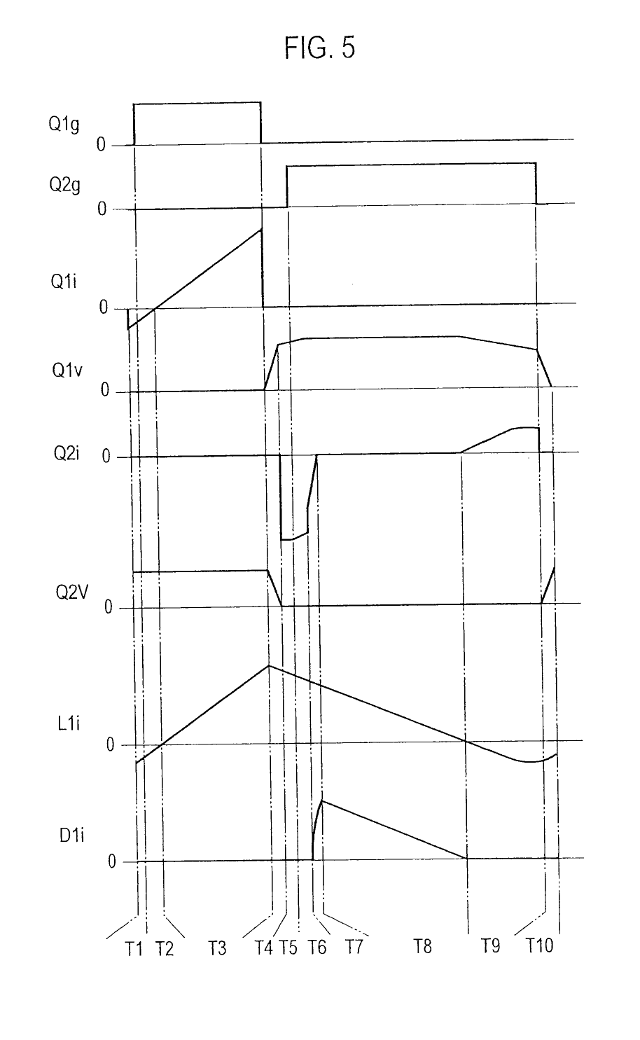

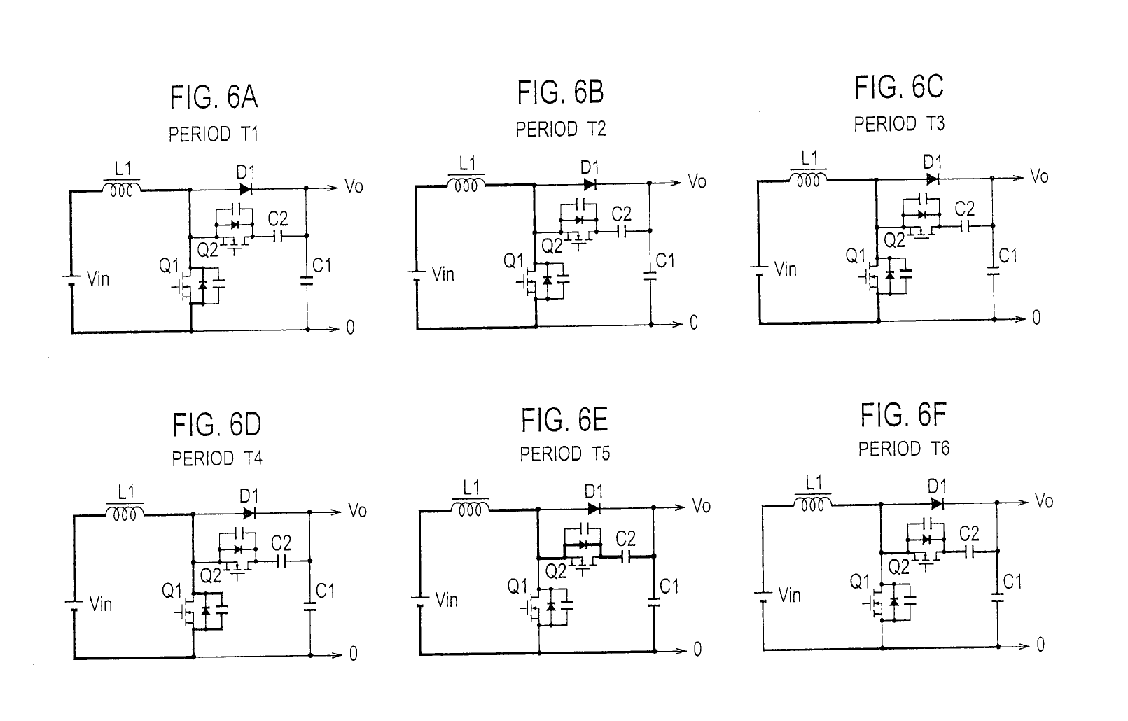

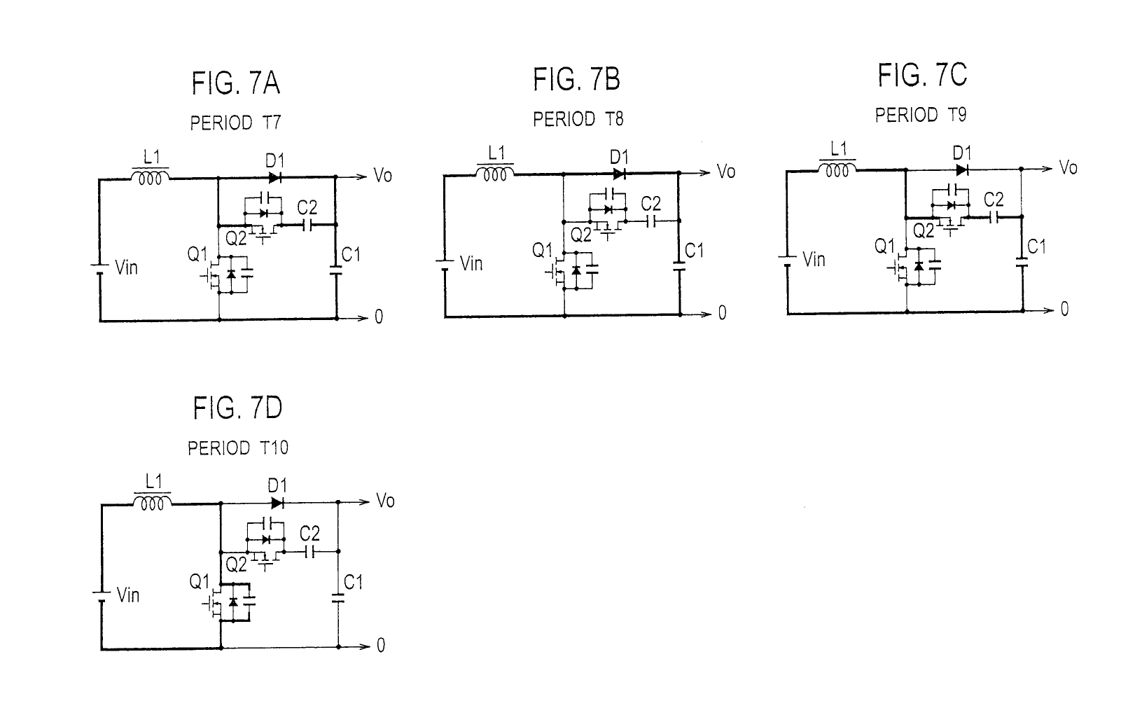

FIG. 5 is a waveform chart showing operations of the respective parts of the switching power supply circuit of Example 1 of the present invention. FIGS. 6A to 6F and FIGS. 7A to 7D are diagrams each showing a current path, in a bold line, which is established when the parts of the switching power supply circuit of Example 1 of the present invention operate in a corresponding period.

Next, descriptions will be given of operations of the parts of the switching power supply circuit of critical type of Example 1 with reference to FIGS. 4 to 7.

First, in a period T1 of FIG. 6A, a current L1i flows through the reactor L1 in a path starting and ending at the reactor L1 after passing the DC power supply Vin, the current detection resistor R1 and a diode Da. A negative current Q1i means that a current flows through the diode Da connected the switching element Q1 in parallel. No current Q2i flows through the switching element Q2.

Next, in a period T2 of FIG. 6B, the switching element Q1 is turned on by the gate signal Q1g while the current is flowing through the diode Da.

Thereafter, in a period T3 of FIG. 6C, a current (positive current Q1i) in a direction opposite to that of the current to flow in the period T1 begins to flow through the switching element Q1. Specifically, the currents Q1i, L1i flow in a path from the positive electrode to the negative electrode of the DC power supply Vin via the reactor L, the switching element Q1 and the current detection resistor R1. Thus, the reactor L1 is excited.

Then, in a period T4 of FIG. 6D, once the switching element Q1 is turned off by the gate signal Q1g, excitation energy of the reactor L1 starts to be released. A capacitor Ca connected to the switching element Q1 in parallel is charged with the released energy. Accordingly, a voltage Q1v of the switching element Q1 increases, and a voltage Q2v between a drain and a source of the switching element Q2 decreases to zero volts in exchange. In this time period, the current L1i of the reactor L1 is gradually decreasing.

Next, after the capacitor Ca is charged, in a period T5 of FIG. 6E, the energy is released from the reactor L1, and the current L1i flows in a path starting and ending at the reactor L1 after passing the diode Db, the capacitor C2, the smoothing capacitor C1 and the DC power supply Vin. The negative current Q2i means that a current is flowing through the diode Db connected the switching element Q2 in parallel.

Thereafter, in a period T6 of FIG. 6F, the switching element Q2 is turned on by the gate signal Q2g while the current is flowing through the diode Db. Thus, zero-voltage switching of the switching element Q2 can be achieved.

Then, in a period T7 of FIG. 7A, the capacitor C2 is gradually charged, and the energy released from the reactor L1 is divided into: the current Q2i to flow in a path from the switching element Q2 to the capacitor C2; and a current D1i to flow through the rectifying diode D1.

Next, in a period T8 of FIG. 7B, when the capacitor C2 is fully charged and the current Q2i no longer flows, the energy released from the reactor L1 is released via the rectifying diode D1.

Thereafter, in a period T9 of FIG. 7C, the currents Q2i, L1i flow in a path starting and ending at the smoothing capacitor C1 after passing the capacitor C2, the switching element Q2, the reactor L1, and the DC power supply Vin, once the excitation energy of the reactor L1 is completely released. Moreover, the reactor L1 is excited in a direction of the path mentioned above.

Then, in a period T10 of FIG. 7D, once the switching element Q2 is turned off by the gate signal Q2g, the voltage Q2v of the switching element Q2 increases. Moreover, energy of the reactor L1 excited in the period T9 is released in the path starting and ending at the reactor L1 after passing the DC power supply Vin, the current detection resistor R1 and the diode Da. Thus, electric charge of the capacitor Ca is discharged, and a current flows through the diode Da. The voltage Q1v between the drain and the source of the switching element Q1 reduces to zero volts.

Note that processes performed in the periods T1, T2 . . . are repeated after the period T10. In the period T2, the switching element Q1 is turned on as described above, and at this time, zero-voltage switching of the switching element Q1 is achieved.

The switching power supply circuit of Example 1 is capable of achieving the zero-voltage switching when the switching element Q1 is turned on, because: the additionally-provided series circuit (active clamp circuit) including the switching element Q2 and the capacitor C2 creates a time period for returning the energy from the load (the smoothing capacitor C1) side to the input (the DC power supply Vin) side, and thereby increases the energy which excites the reactor L1 to the input side, i.e., the circulating energy to flow to the input side; and thus the electric charges of the capacitor Ca are extracted by the circulating energy to thereby reduce the voltage of the switching element Q1 to zero volts.

Accordingly, the resonance operation can be achieved in a wider input voltage range and load region can be achieved using a conventional reactor without provision of a resonance reactor. Thus, a highly efficient switching power supply circuit can be provided.

Moreover, an on-period of the switching element Q1 becomes longer, and a time length in which the increased portion of the excitation energy is released through the rectifying diode D1 (off-period of the switching element Q1) also becomes longer. In other words, a switching frequency of the switching element Q1 decreases.

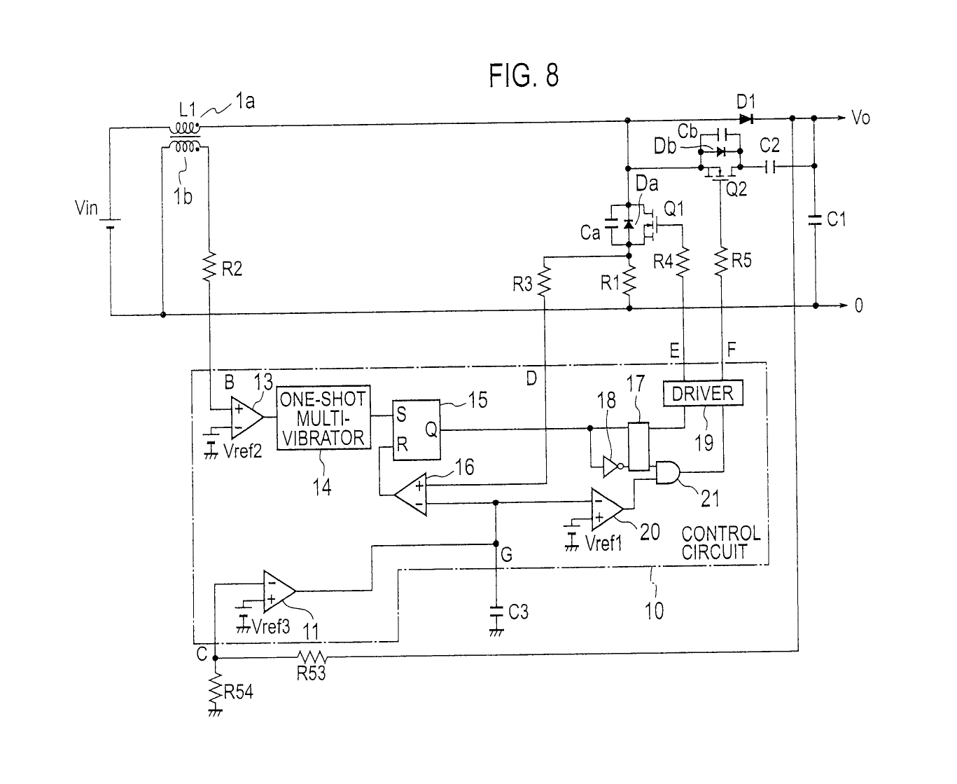

Next, a description is given of an operation of turning on and off the switching element Q2 in accordance with a load state (load amount). FIG. 8 is a diagram showing an example of the control circuit of the switching power supply circuit of Example 1 of the present invention in detail. The control circuit 10 shown in FIG. 8 is a circuit configured to control the on and off of the switching element Q2 in accordance with the load state.

The control circuit 10 includes an error amplifier 11, a comparator 13, an one-shot multivibrator 14, a flip-flop circuit 15, a comparator 16, a dead time generation circuit 17, an inverter 18, a driver 19, a comparator 20, and an AND circuit 21.

The comparator 13 compares a voltage of the criticality detection winding 1b inputted via a resistor R2 with a reference voltage Vref2. Upon receiving an L-level signal from the comparator 13, the one-shot multivibrator 14 outputs one pulse, as a set signal, to a set terminal of the flip-flop circuit 15.

The flip-flop circuit 15 is set in response to the set signal, and outputs an H-level signal from a Q output terminal. The flip-flop circuit 15 thus turns on the switching element Q1 via the dead time generation circuit 17, the driver 19, and a resistor R4. Once the switching element Q1 is turned on, a current flows in the path from the positive electrode to the negative electrode of the DC power supply Vin via the reactor L1, the switching element Q1 and the current detection resistor R1, as well as the reactor L1 is charged with energy. The current detection resistor R1 converts the current flowing through the switching element Q1 to a voltage, and outputs the converted voltage to a non-inverting input terminal of the comparator 16 via a resistor R3.

The error amplifier 11 amplifies an error voltage between a reference voltage Vref3 and a divided voltage obtained by dividing a voltage of the smoothing capacitor C1 between a resistor R53 and a resistor R54, as well as outputs this error voltage to the comparators 16, 20 and a capacitor C3.

The comparator 16 compares a current target value Vm outputted from the error amplifier 11 with a voltage to occur at the current detection resistor R1. Once the current Q1i of the switching element Q1 reaches the current target value Vm, the comparator 16 outputs an H-level reset signal to the flip-flop circuit 15. The flip-flop circuit 15 is reset in response to the reset signal from the comparator 16, and switches the H-level signal, which has been outputted from the Q output terminal, to an L-level signal. Thus, the switching element Q1 is turned off.

Once the switching element Q1 is turned off, the energy with which the reactor L1 is charged is released. Once this energy release is completed, the voltage of the criticality detection winding 1b is inverted. The comparator 13 compares the inverted voltage with the reference voltage Vref2, and outputs an L-level signal to the one-shot multivibrator 14. Because the one-shot multi-vibrator 14 outputs one pulse to the set terminal of the flip-flop circuit 15, the switching element Q1 is thus turned on again.

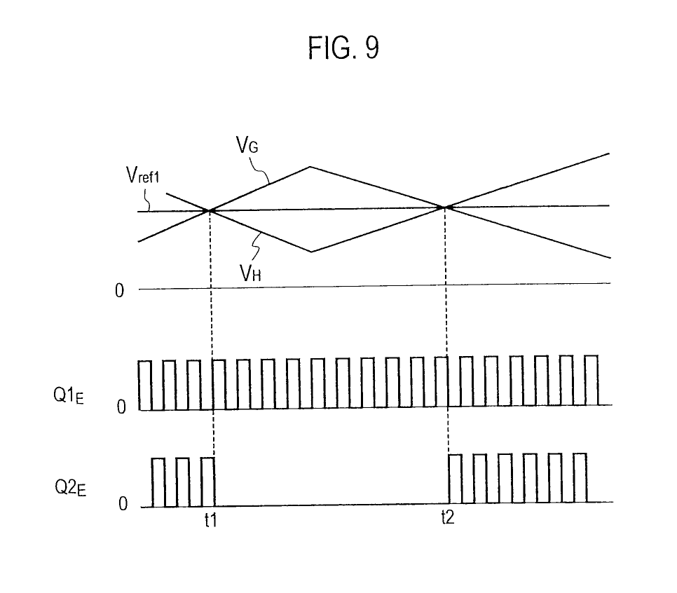

The switching element Q1 repeats the on and off operations described above, and a switching waveform Q1E shown in FIG. 9 is formed.

Next, an operation of the switching element Q2 is described. The capacitor C3 is charged by the voltage obtained by dividing the voltage of the smoothing capacitor C1 between the resistor R53 and the resistor R54, i.e. a voltage corresponding to a state of a load (not illustrated) connected to the smoothing capacitor C1, which is outputted from the error amplifier 11.

While a voltage VG of the capacitor C3 is equal to or larger than a reference voltage Vref1 (from time t1 through time t2 in FIG. 9), i.e. while the load is a heavy load, the comparator 20 outputs an L-level signal to the AND circuit 21. This causes the AND circuit 21 to output the L-level signal to the driver 19, and the driver 19 thus turns off the switching element Q2.

On the other hand, while the voltage VG of the capacitor C3 is smaller than the reference voltage Vref1 (before time t1 and after time t2 in FIG. 9), i.e. while the load is a light load, the comparator 20 outputs an H-level signal to the AND circuit 21. The inverter 18 inverts the signal from the flip-flop circuit 15, and outputs the inverted signal to the AND circuit 21. The AND circuit 21 outputs the inverted signal to the driver 19, as well as the driver 19 thus turns on and off the switching element Q2.

Like the conventional switching power supply circuit, as described above, the switching power supply circuit of Example 1 is capable of operating the switching element Q1 in the zero-voltage switching operation by operating only the switching element Q1 without operating the switching element Q2 (an OFF state), when the load is a heavy load.

Moreover, the conventional switching power supply circuits deteriorates the efficiency since the conventional switching power supply circuit has an increases in the switching frequency and fails to perform the zero-voltage switching operation when the load is a light load. On the other hand, the switching power supply circuit of Example 1 is capable of enhancing the efficiency since, when the load is a light load, the switching power supply circuit of Example 1 operates the active clamp circuit including the switching element Q2 and the capacitor C2 to fully operate the switching elements Q1, Q2 in the zero-voltage switching operations and to make the switching frequency lower than the switching frequency of the conventional switching power supply circuit.

Furthermore, the switching power supply circuit described in Japanese Patent Application Publication No. 2004-327152 achieves the zero-voltage switching by making the current flow to the load side in the path starting and ending at the switching element Q1 via the resonance reactor, the rectifying diode D1, the smoothing capacitor C1 and the current detection resistor R1, when the switching element Q2 is turned off.

On the other hand, the switching power supply circuit of Example 1 regenerates an output into an input (DC power supply Vin), and makes a current flow to the input side in the path starting and ending at the reactor L1 after passing the DC power supply Vin, the current detection resistor R1 and the switching element Q1 when the switching element Q2 is turned off. Thus, the configuration and operation of the switching power supply circuit of Example 1 are completely different from those of Japanese Patent Application Publication No. 2004-327152.

Furthermore, the switching frequency cannot be decreased in the switching power supply circuit described in Japanese Patent Application Publication No. 2004-327152. On the other hand, the switching power supply circuit of Example 1 has an advantage that the switching frequency can be decreased.

### Example 2

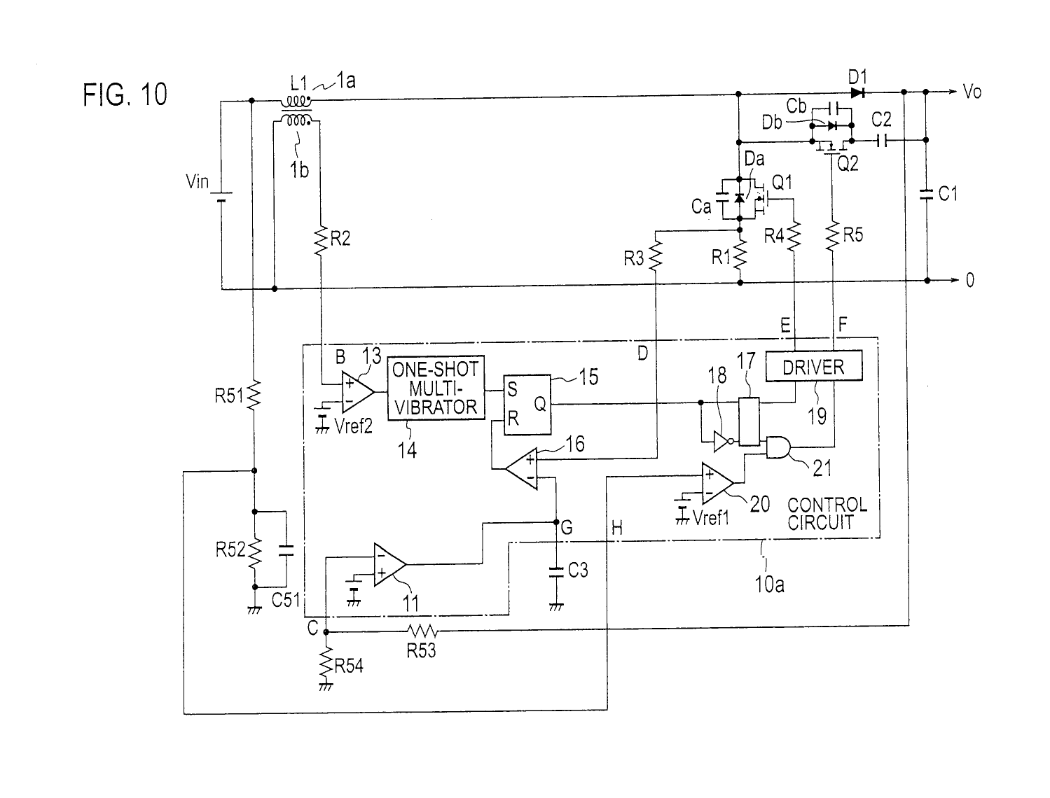

FIG. 10 is a diagram showing a control circuit provided in a switching power supply circuit of Example 2 of the present invention. A control circuit 10a of the switching power supply circuit of Example 2 is characterized in that the on and off of a switching element Q2 is controlled in accordance with a voltage of a DC power supply Vin (input voltage).

The switching power supply circuit of Example 2 shown in FIG. 10 is different from the switching power supply circuit of Example 1 shown in FIG. 8 in that, as an input voltage, a divided voltage VH obtained by dividing the voltage of the DC power supply Vin between a resistor R51 and a resistor R52 is inputted to a non-inverting input terminal of a comparator 20.

While the divided voltage VH is less than a reference voltage Vref1 (from time t1 through time t2 in FIG. 9), the comparator 20 outputs an L-level signal to the AND circuit 21. This causes the AND circuit 21 to output the L-level signal to the driver 19, and the driver 19 thus turns off the switching element Q2.

On the other hand, while the divided voltage VH is equal to or more than the reference voltage Vref 1 (before time t1 and after time t2 in FIG. 9), the comparator 20 outputs an H-level signal to the AND circuit 21. The inverter 18 inverts a signal from the flip-flop circuit 15, and outputs the inverted signal to the AND circuit 21. The AND circuit 21 outputs the inverted signal to the driver 19, and the driver 19 thus turns on and off the switching element Q2.

As described above, the switching power supply circuit of Example 2 is capable of enhancing the efficiency since, when the voltage of the DC power supply Vin is high, the switching power supply circuit of Example 2 operates the active clamp circuit including the switching element Q2 and the capacitor C2 to fully operate the switching elements Q1, Q2 in the zero-voltage switching operations and also to make the switching frequency lower than the switching frequency of the conventional switching power supply circuit.

### Example 3

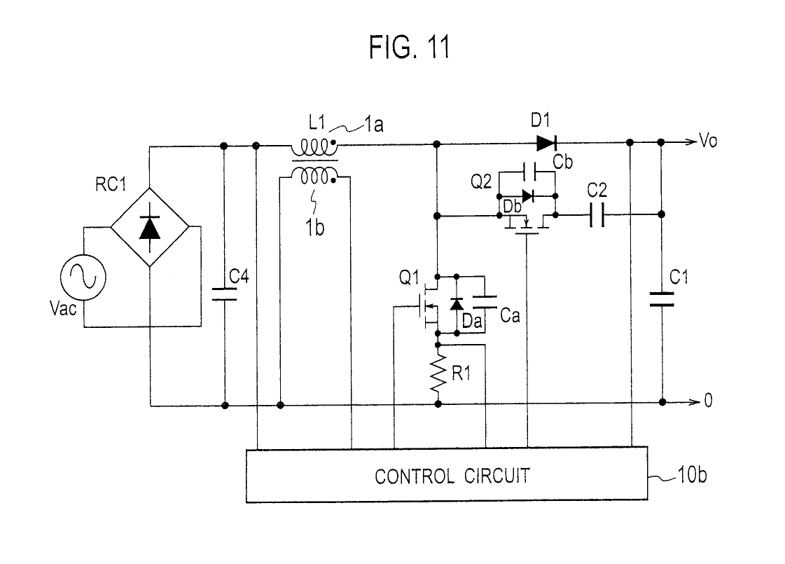

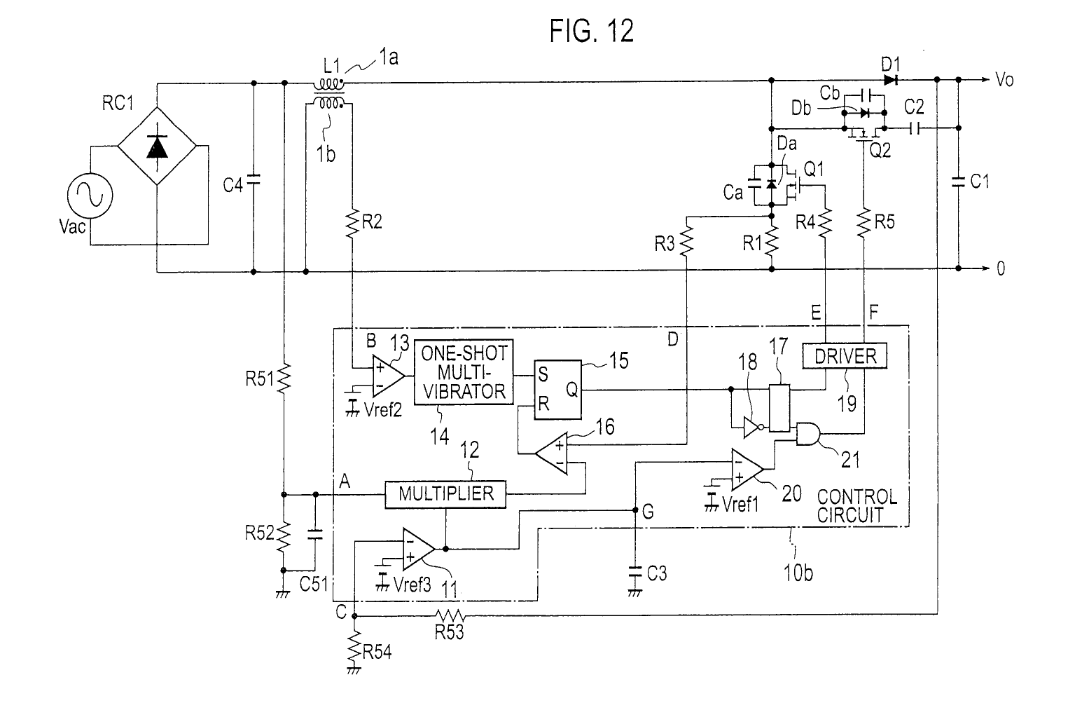

FIG. 11 is a configuration diagram of a switching power supply circuit of Example 3 of the present invention. The switching power supply circuit of Example 3 shown in FIG. 11 is characterized in that the circuit is a power factor correction circuit (PFC) provided with an AC (alternating current) power supply Vac, a rectifying circuit RC1, and a capacitor C4 (third capacitor) instead of the DC power supply Vin of the switching power supply circuit shown in FIG. 4.

The AC power supply Vac supplies an AC voltage to the rectifying circuit RC1. The rectifying circuit RC1 rectifies the AC voltage from the AC power supply Vac. The capacitor C4 constitutes a path of energy which excites a reactor L1 to an input side, i.e. circulating energy to flow to the input side.

FIG. 12 is a diagram showing a control circuit provided in the switching power supply circuit of Example 3 of the present invention. Compared to the control circuit 10 shown in FIG. 8, a control circuit 10b shown in FIG. 12 is characterized by further including: a series circuit including a resistor R51 and a resistor R52 which is connected between one end of the capacitor C4 and the ground; and a multiplier 12 connected to the resistor R51 and the resistor R52.

The multiplier 12 multiplies a rectified voltage divided by the resistor R51 and the resistor R52 by a voltage from an error amplifier 11, and outputs the obtained voltage to a inverting input terminal of a comparator 16.

The switching power supply circuit of Example 3 is capable of enhancing the efficiency since the switching power supply circuit of Example 3 enhances the power factor, and operates in the same manner as does the switching power supply circuit of Example 1, as well as since, when the load is a light load, the switching power supply circuit of Example 3 operates the active clamp circuit including the switching element Q2 and the capacitor C2 to fully operate the switching elements Q1, Q2 in the zero-voltage switching operations, and also to make the switching frequency lower than the switching frequency of the conventional switching power supply circuit.

### Example 4

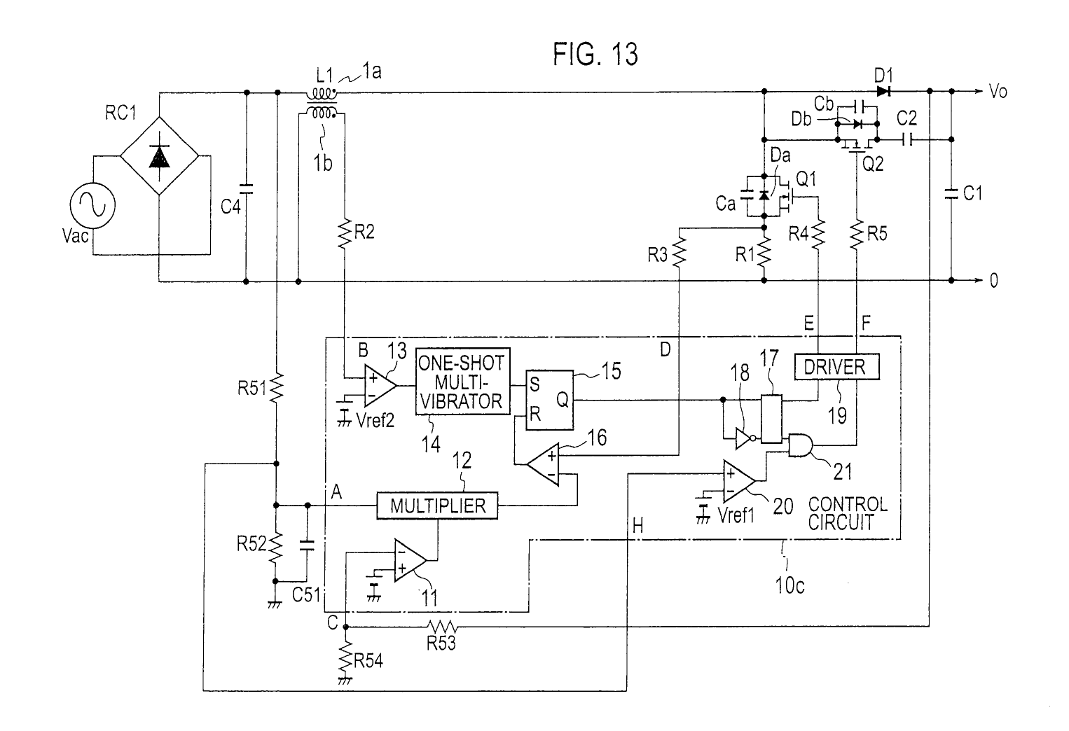

FIG. 13 is a diagram showing a control circuit provided in a switching power supply circuit of Example 4 of the present invention. On the whole, the switching power supply circuit of Example 4 shown in FIG. 13 is the same as the switching power supply circuit of Example 3 shown in FIG. 11, but is different in that a control circuit 10c is provided instead of the control circuit 10b.

Compared to the control circuit 10a shown in FIG. 10, the control circuit 10c shown in FIG. 13 is characterized by further including a multiplier 12 connected to a resistor R51 and a resistor R52.

The multiplier 12 multiplies a rectified voltage divided by the resistor R51 and the resistor R52 by a voltage from an error amplifier 11, and outputs the obtained voltage to a inverting input terminal of a comparator 16.

The switching power supply circuit of Example 4 is capable of enhancing the efficiency since the switching power supply circuit of Example 4 enhances the power factor, and operates in the same manner as does the switching power supply circuit of Example 2, as well as since, when the AC voltage of the AC power supply Vac is high, the switching power supply circuit of Example 4 operates the active clamp circuit including the switching element Q2 and the capacitor C2 to fully operate the switching elements Q1, Q2 in the zero-voltage switching operations, and also to make the switching frequency lower than the switching frequency of the conventional switching power supply circuit.

Note that the present invention is not limited to the switching power supply circuits of Examples 1 to 4. For example, the control circuit 10 of the switching power supply circuit of Example 1 shown in FIG. 8 and the control circuit 10a of the switching power supply circuit of Example 2 shown in FIG. 10 may be used in combination. Moreover, the control circuit 10b of the switching power supply circuit shown in FIG. 12 and the control circuit 10c of the switching power supply circuit shown in FIG. 13 may be used in combination.

The present invention can achieve the zero-voltage switching when the first switching element is turned on, because: the additionally-provided second switching element and second capacitor creates a time period for returning the energy from the load side to the input side, and thereby increases the energy which excites the reactor to the input side, i.e., the circulating energy to flow to the input side; and thus, this energy reduces the voltage of the first switching element to zero volts.

Accordingly, the present invention can achieve the resonance operation in a wider input voltage range and load region by using a conventional reactor without provision of a resonance reactor. Thus, the present invention can provide a highly efficient switching power supply circuit.

The present invention is applicable to a DC-DC converter, a power factor correction circuit, and an AC-DC converter.

What is claimed is:

1. A switching power supply circuit comprising:
a first series circuit which is connected between one end and the other end of a DC power supply and in which a reactor, a first diode, and a first capacitor are connected in series;
a first switching element connected between the one end of the DC power supply and a connection point between the reactor and the first diode;
a second series circuit which is connected to the first diode in parallel, and in which a second switching element and a second capacitor are connected in series; and
a control circuit configured to control on and off of the second switching element in order that turn on of the first switching element becomes to zero-voltage switching.

2. The switching power supply circuit of claim 1, wherein the control circuit controls the on and off of the second switching element in response to at least one of a voltage from the DC power supply and a voltage from the first capacitor.

3. The switching power supply circuit of claim 2, wherein the control circuit makes control to turn off the second switching element at least either when the voltage from the DC power supply does not represent a high input voltage or when the voltage from the first capacitor does not represent a light load.

4. The switching power supply circuit of claim 1, wherein
the DC power supply includes an AC power supply, a rectifying circuit and a third capacitor, and
the control circuit makes control to enhance a power factor.
